(19) United States
(12) Patent Application Publication
(10) Pub. No.: US 2010/0017418 A1
(43) Pub. Date: Jan. 21, 2010

(54) METHOD OF PRESENTING A TOPOLOGY, USING A VISUAL OBJECT

(75) Inventors: Ranjith Gopalakrishnan, Bangalore (IN); Rajendra Singh Sisodia, Bhopal (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,105

(22) PCT Filed: Dec. 20, 2005
(86) PCT No.: PCT/IB05/54336

§ 371 Date: Jun. 19, 2007

(30) Foreign Application Priority Data
Dec. 22, 2004 (EP) 04106874.3

(51) Int. Cl. G06F 17/00; G06F 17/30

(52) U.S. Cl. 707/100; 715/234; 707/E17.044

(57) ABSTRACT

The invention relates to a method of presenting a topology comprising a reference with at least one sub-reference, and an apparatus for presenting the topology. The method comprises the steps of: (110) obtaining topology data representing the topology, —(120) processing the topology data so as to represent the topology by means of a visual object (250) associated with the reference, said object being configured to be visualized in any of a plurality of visual modes, wherein a specific one of the one or more sub-references is associated with a specific one of the plurality of visual modes. A user may browse hierarchical information (the topology data), using the visual object, e.g. by rotating the visual object to a desired visual mode in order to find a desired element of the topology.

The invention relates to a method of presenting a topology comprising a reference with at least one sub-reference, and an apparatus for presenting the topology.

US2004/0054667 discloses a method of displaying a three-dimensional visual object associated with an Internet website. Information about the website is obtained, such as response time, update status and congestion status. The visual object, e.g. a building-like shape, is displayed on the basis of information about the website. For example, the shape of the building is determined by a “type” of website, e.g. news, sport and the like. The height of the building corresponds to the response time. A user may change a point of view of the shape of the building to see a name of the website.

It is observed that the presentation of the website in the form of a building allows showing only a limited amount of information about individual websites to the user. In addition, the virtual building is a cumbersome way of presenting the information about the website.

It is desirable to overcome the drawback of the prior-art presentation method, and to provide a method of presenting a topology comprising a reference with at least one sub-reference.

The method comprises the steps of obtaining topology data representing the topology, and processing the topology data so as to represent the topology by means of a visual object associated with the reference. The object is configured to be visualized in any of a plurality of visual modes, wherein a specific one of the one or more sub-references is associated with a specific one of the plurality of visual modes.

The term “topology” refers to the concept of a specific organization of data, e.g. a hierarchical organization. Here, the topology data is understood to comprise the reference and the sub-references (to information, storage location of information, etc). The topology may be found, for example, in an organization of media content. For instance, a website has a URL (Uniform Resource Locator) address at which a main web page is accessible. In turn, the main web page may have a plurality of sub-pages with URL sub-addresses. In this example of the website, the URL address and the URL sub-addresses are the reference and the sub-references. The topology data does not comprise content of any web page. The references and the sub-reference may merely be pointers to e.g. media content or hierarchically networked devices. The URI (Uniform Resource Identifier) standard, which includes both URLs and URNs (Uniform Resource Name), may also be used as a means for representing the topology and accessing media content.

The topology data indicates that the reference has one or more sub-references. For example, the URL address specifies a location of a HTML document (HyperText Markup Language), i.e. the main web page. The main web page comprises a plurality of other URL addresses, i.e. the URL sub-addresses. The hierarchy of the web pages and its sub-pages may be determined from the format of URL addresses: e.g. a URL address “http://www.philips.com” is the reference, and a URL sub-address “http://www.philips.com/contact” is the sub-reference. Therefore, the hierarchy in the topology may be determined from the reference and sub-reference themselves without resorting to the content addressed by the reference and the sub-references.

The topology may be presented by using the visual object, e.g. a 3D (three-dimensional) graphical object, which has various visual modes. For example, the 3D object may be displayed in various orientations showing different faces of the object. Each respective one of the visual modes of the object is associated with a respective one of the sub-references. For example, a specific sub-reference is associated with a specific one of multiple faces of the visual object.

In one embodiment, the method according to the invention further comprises a step of visualizing the visual object in the specific one of the plurality of visual modes associated with the specific one of the one or more sub-references.

In a further embodiment, the method further comprises a step of selecting a particular one of the one or more sub-references of the topology. The method preferably comprises a step of changing the visual mode in order to select another one of the sub-references. By selecting between the visual modes of the visual object, the relevant sub-reference in the topology is selected. Basically, the visual object enables a user to browse the topology, e.g. by manipulating the visual object so that it assumes one of the visual modes.

Another embodiment of the method according to the invention comprises a step of assigning, to the specific one of the sub-references, a specific code for identifying the specific one of the plurality of visual modes. The method preferably further comprises a step of obtaining the topology data comprising the specific code via a client device, and a step of visualizing the visual object in the specific one of the plurality of visual modes identified by the specific code.

In a further embodiment of the method according to the invention, the reference is associated with a URL-address (Uniform Resource Locator) of a collection of information items, and respective ones of the sub-references are associated with a respective URL sub-address of a respective one of the information items.

In one of the embodiments, the visual object is a small 3D cube for navigating the topology of the website. The cube is so small that it may not show the URL links of the website or the content of web pages of the website. The cube can be rotated in different planes. The hierarchy of the topology is such that it has a first level of first sub-references and a second level of second sub-references. A rotation of the cube in one plane allows choosing the first level and the second level. A rotation of the cube in another plane allows selecting between the sub-references of the first level or between the sub-references of the second level, depending on the level that has been chosen.

The invention further relates to an apparatus for presenting a topology comprising a reference with at least one sub-reference. The apparatus comprises a data processor for obtaining topology data representing the topology, and for processing the topology data so as to represent the topology by means of a visual object associated with the reference. The object is configured to be visualized in a plurality of visual modes, wherein a specific one of the one or more sub-references is associated with a specific one of the plurality of visual modes.

In one embodiment, the apparatus is a data server in a data network, e.g. the Internet. A client device is coupled to the data server via the data network. The data processor of the data server is configured to process the topology data and transmit the processed topology data to the client device. For instance, each sub-reference of the topology is given a respective code (identifier). The code is added to the topology data to be transmitted to the client device.

The data server may indicate a visual mode corresponding to the respective code (if the data server is capable of accessing information about the visual object and its visual modes). Alternatively, the client device determines which visual mode corresponds to the particular code.

After the client device has received the encoded topology data, a particular sub-reference is associated with the respective visual mode. The client device, which stores visual data of the visual object, visualizes (e.g. displays) the visual object in one of the visual modes so that the respective sub-reference is selected.

In another embodiment, the data server is not required. The apparatus comprises a memory for storing the visual object, and a visualizing unit for visualizing the object in a specific one of the visual modes.

When a user likes to browse the website, the visual object advantageously allows browsing the topology of the website without displaying the web pages. Loading and displaying the main web page in order to click on a link to the sub-page would be a time-consuming process that might annoy the user if he was not interested in the content of the main web page. Advantageously, the user may quickly and efficiently browse the topology to find a desired element (sub-reference) of the topology.

URL addresses are text strings. If the reference and sub-references are URL addresses, the references or sub-references may be associated with the respective visual modes of the visual object by means of graphic icons, logos, etc. without presenting the text strings. In that way, the presentation of the topology is user-intuitive. The space is saved on a display screen because the presentation of the visual object requires less space on the screen than the display of the text strings. Alternatively, the visual object does not bear any sign that indicates which reference is associated with the particular visual mode, but the reference is selected by changing the visual mode of the visual object in a particular manner (e.g. as in the embodiment of the 3D cube above).

Moreover, the visual object may have such sizes when it is presented on the display screen that the visual object is suitable to be presented on a small portable display device. It is cumbersome to present the URL addresses on the portable display devices, e.g. mobile phones.

The invention further relates to a computer program product enabling a programmable device, when executing the computer program of the product, to function as the apparatus specified above. The invention further relates to a computer program product allowing implementation of a method according to the invention, when the computer program of the product is being executed. The computer programs may be user-programmable in the sense of enabling the user to specify a mapping of the topology onto the object.

The invention further relates to a data structure for presenting a topology comprising a reference with one or more sub-references. The data structure comprises topology data representing the topology. The topology data is operative to represent the topology by means of a visual object associated with the reference. The object is configured to be visualized in any of a plurality of visual modes, wherein a specific one of the one or more sub-references is associated with a specific one of the plurality of visual modes.

These and other aspects of the invention will be further explained and described, by way of example, with reference to the following drawings:

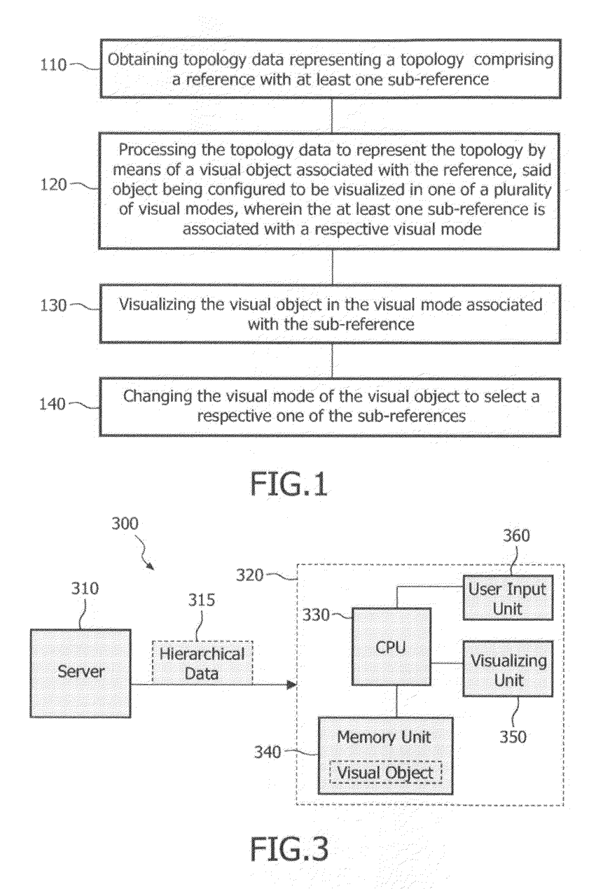

FIG. 1 shows an embodiment of the method of the present invention;

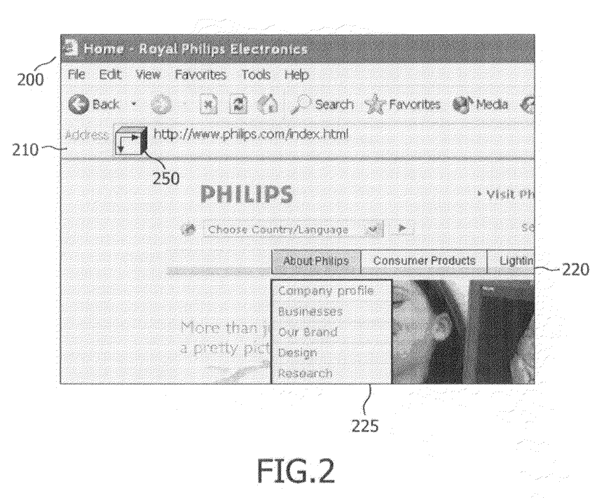

FIG. 2 shows an embodiment of a presentation of a topology;

FIG. 3 is a functional block diagram of an embodiment of the apparatus according to the present invention.

Information is typically organized in a particular structure so as to facilitate navigation of the information. For example, music is organized in various types such as rock, classical, pop or jazz. Movies are classified with respect to genres, e.g. action, fiction, thriller or drama. Documents are divided into chapters. Websites are organized in a main web page, and sub-pages, and the main pages may incorporate URL addresses into the sub-pages. An XML code may be used for representing structured information.

The information may be navigated in many manners. Centric navigation allows a user to browse the information in a virtual space, for example, following a hypertext link, zooming into a 2D interface, and moving to a different 3D room or different view of a 3D visualization. A second type of navigation relates to a transformation and/or manipulation of virtual objects, which is basically the transforming or manipulating of abstract representations of an information structure. A third type of navigation provides an overview of information on the basis of a structure of the information, and leads a user to a part of the information that is of interest to the user. The present invention will be further explained with reference to the second navigation type.

The information having a topology is usually structured in different levels so that a part of the information comprises a sub-part. The part and the sub-part of the information are “marked” with a reference and a sub-reference. The information may be media content or other data, e.g. a computer network infrastructure or a digital library catalog.

The media content may comprise at least one of, or any combination of, visual information (e.g. video images, photos, graphics), audio information, text information, and other digital data such as e.g. meta-data according to the MPEG-7 standard which may be used to describe and search digitized materials by means of sampling, as well as by using lexical search terms. The expression “audio information” is hereinafter used as data pertaining to audio comprising audible tones, silence, speech, music, tranquility, external noise or the like. The audio information may be in formats like the MPEG-1 layer III (mp3) standard (Moving Picture Experts Group), AVI (Audio Video Interleave) format, WMA (Windows Media Audio) format, etc. The expression “video information” is used as data which are visible such as a motion picture, “still pictures”, video text, etc. The video information may be in formats like GIF (Graphic Interchange Format), JPEG (named after the Joint Photographic Experts Group), MPEG-4, etc. The text information may be, for example, in the ASCII (American Standard Code for Information Interchange) format, PDF (Adobe Acrobat Format) format, HTML (HyperText Markup Language) format. The meta-data may be in the XML (Extensible Markup Language) format, MPEG7 format, stored in a SQL database or any other format.

The reference and the sub-reference may essentially be pointers, marks or addresses. For example, the reference or the sub-reference is a URL address, or a FRAMESET tag which describes a sub-HTML document (a frame) that makes up a HTML document. In another example, the reference is a title of a document, and the sub-reference is a title of a chapter of the document. The chapter is readily accessible by means of the sub-reference. In a further example, the reference corresponds to a genre type of music files (e.g. rock) stored in a database, and the sub-reference corresponds to a sub-genre type of some music files (e.g. hard (rock)). The music file may have meta-data indicating the genre and sub-genre, so that it is possible to identify the music files having a particular genre type or a particular sub-genre type.

FIG. 1 shows an embodiment of the method of the present invention. In step 110, topology data representing the topology is obtained. For example, a list of URL links of a website is received from an Internet server. Alternatively, a list of genres and respective sub-genres is extracted from meta-data. In a further example, a document is analyzed to derive a structure of the document (chapters, sub-chapters, etc).

In step 120, the topology data is processed so that a User Interface (UI) is generated on the basis of a virtual visual object to navigate the topology. The visual object is suitable to be visualized in one of a plurality of visual modes. The visual object may be controlled to change from one visual mode to another visual mode in response to a user command or automatically under the control of a computer program. The topology is navigated and a particular reference or sub-reference is selected, e.g. when the visual object is visualized in a respective one of the visual modes, or when the visual object is manipulated by a user to change between certain visual modes in a pre-determined manner.

In step 130, the visual object is visualized. The visual object may be a geometrical three-dimensional shape which is easy and intuitive for the user to navigate. For instance, a 3D cube, sphere or a similar form is relatively ergonomic. It is an advantage of the present invention that the visual object may be used to merely control the navigation of the topology, without displaying web pages, documents, etc. on the visual object itself. The visual object does not need to bear any signs, pictures, etc. which require a lot of space to be displayed to the user. Therefore, the visual object may be relatively small. Due to the small size of the visual object, it is a very convenient way of topology navigation, especially on a display of a portable device which usually has relatively small dimensions.

In step 140, the visual object is controlled to change its presentation (e.g. a position or an orientation on a display screen) so that one visual mode is replaced by another visual mode of the visual object. For example, the 3D cube with six faces of different colors is rotated to show a second face in place of a previously shown first face. In one embodiment, the first face may correspond to the reference of the topology, and the second face may be a command to select one of the sub-references. If the cube is further rotated to a third face, a command to select a next one of the sub-references may be automatically executed. The selection of the (sub-)reference may optionally trigger an action to be performed, e.g. a playback of a song, displaying a list of content items of a particular sub-genre type, or displaying a corresponding URL-link.

FIG. 2 shows an embodiment of the User Interface comprising the visual object shown on a display screen 200. In this embodiment, the topology comprises a hierarchical organization of information of web pages of the website with a main web page having a URL address “http://www.philips.com/index.html”. The URL address is shown in an address line 210, which is available in most Internet browsers. The main web page has sub-pages that are accessible if URL links are activated, e.g. using a computer mouse. For instance, the main web page splits into first sub-pages (first sub-references of the topology) “About Philips”, “Consumer Products”, “Lighting” shown in a menu 220. The first sub-page “About Philips” has second sub-pages “Company profile”, “Business”, “Our Brand”, etc. shown in a list 225 activated upon a mouse click on the menu item “About Philips”.

The topology is mapped on the visual object presented as a 3D cube 250. The cube is preferably placed in the beginning of the address line so that the navigation of the cube does not disturb other elements of the UI, e.g. in front of the URL address. In this example, three out of six faces of the cube 250 are displayed. The cube does not display the menu items of the menu 220 or the list 225. Optionally, navigation indicators, e.g. graphic arrows, are displayed on a face of the cube which is shown as the currently largest. The arrows may indicate a direction in which the cube may be user-operably rotated to navigate the topology. For instance, a horizontal arrow indicates that, if the cube is navigated in the horizontal direction, the menu items “About Philips”, etc. (i.e. the first sub-references) are selectable. If a vertical arrow is followed and the cube is rotated in a vertical direction, the second sub-references, i.e. the second sub-pages “Company profile”, etc. are selectable.

In one embodiment, the cube is associated with the reference being the URL address of the main web page of the website. Upon rotation of the cube in the horizontal direction, a text string of the URL address of the main web page is replaced by a text string corresponding to the first sub-reference, i.e. a URL address of one of the first sub-pages. The manipulation, e.g. the rotation, of the cube may be controllable by pressing left/right keys of a computer keyboard, by pointing at the cube using the computer mouse and moving a pointer of the computer mouse in the horizontal direction, while holding a left or right button of the computer mouse, or in another manner.

In another embodiment, in response to the rotation of the cube horizontally or vertically, a title of one of the first or second sub-pages is displayed in the address line instead of the URL addresses. Usually, the URL addresses are long text strings. Therefore, the title will be shorter, and a lot of space of the display screen 200 may be saved.

In a further embodiment, the manipulation of the cube allows selection of the reference or the sub-reference of the topology, and the web page corresponding to the selected reference or the sub-reference is automatically downloaded and displayed on the display screen. The user does not have to click on a link in the currently shown web page in order to download and display a web page corresponding to the link, and, therefore, the user does not have to move the computer mouse around the web page.

It is also possible that the sub-references (e.g. the first or the second sub-page) are automatically displayed one after another in the address line (only one or few sub-references at a time, not the whole topology) in a sequence determined by the topology (similar to a “running text” principle), but the rotation of the cube determines that the first sub-references or the second sub-references are shown.

The visual object may be presented in any other form than the 3D cube, e.g. 3D trapezium or another 3D polygon. In other words, the 3D cube is merely an example.

FIG. 3 shows an embodiment of the present invention. A system 300 comprises a data server 310 and a client device 320. The data server 310 comprises an encoding processor (not shown) for obtaining topology data (hierarchical data) representative of the topology, e.g. from an Internet server for maintaining a website. The topology data may be a set of URL links defining the structure of a website, database of content items, e.g. movies, songs, etc. or lists of media content genres (e.g. action or nature) for respective ones of media content types (e.g. movie or documentary), and sub-genres of the genres (e.g. sea life). The encoding processor may be configured to encode the topology data by adding a code to the respective reference or sub-reference of the topology data. The code may be used by the client device to couple one of the visual modes of the visual object with the respective reference or the sub-reference, or to associate the rotation of the visual object in a particular manner with the respective reference or the sub-reference.

In one embodiment, the encoding processor is configured to obtain navigation control data of the visual object, e.g. from the client device. The navigation control data may be a list of the visual modes of the visual object. Each visual mode may be associated with the respective code (the code is later added by the encoding processor to the respective reference or the sub-reference, as stated in the preceding paragraph).

In addition, the navigation control data may specify possible transitions between the visual modes of the visual object, manipulations which the user may perform with the visual object to affect the transitions. The information about the possible transitions and the manipulations may affect the addition of the codes to the topology data by the encoding processor. For example, the cube 250 in FIG. 2 has codes 1, 2 and 3 associated with the respective faces shown vertically (at the particular shown position) in FIG. 3. The horizontal rotation of the cube (i.e. in a plane perpendicular to the display screen 200 and along the address line 210), e.g. by pressing keys right/left of a computer keyboard, allows moving the cube into a position in which the face with the code 1, 2 or 3 is shown most visible on the display screen 200. Given the example of the topology with the first sub-references 220 and the second sub-references 225, the assignment of the first sub-references to the vertical faces of the cube seem to be most logical because the first sub-references 220 are positioned horizontally on the display screen 200, and the horizontal rotation of the cube is the most user-intuitive in this case. Hence, the encoding processor may analyze the topology data and determine that the codes 1, 2 and 3 must be assigned to the three URL addresses of the first sub-references “About Philips”, “Consumer Products” and “Lighting”, respectively.

The encoding processor may further be configured to transmit the encoded topology data (hierarchical data 315) to the client device 320, e.g. via a satellite, terrestrial, cable or other link. For instance, the list of the encoded URL addresses is sent to the client device:

“http://www.philips.com/index.html?code=0”,
“http://www.philips.com/about/?code=1”,
“http://www.consumer.philips.com/consumer/catalog/catalog_selector.jsp?code=2”,
“http://www.lighting.philips.com/gl_en/index.php?code=3”.

In this example, the code 0 is added to the main web page of the website. Generally, the code 0 may be added to the reference which is highest in the topology.

The client device 320 comprises a decoding processor 330 for receiving and decoding the encoded topology data 315 to map the reference or the sub-reference to the respective one of the visual modes of the visual object. Information about the visual object including its visual modes and the corresponding codes of the visual modes may be stored in a memory unit 340 of the client device 320. The decoding processor 330 may read the information about the visual modes and corresponding codes from the memory unit 340, analyze the encoded topology data 315 to determine whether any code is found in the encoded topology data, which is identical to the codes read from the memory unit 340. If the code is found, the decoding processor may extract the reference (e.g. the URL address) attached to the code. The decoding processor is configured to control visualization of the visual object on a visualizing unit 350, e.g. a computer monitor. For instance, the decoding processor 330 reads the information about the visual object for the memory unit 340 and displays the 3D cube on the computer monitor 350.

The memory unit 340 may further store the navigation control data for enabling the decoding processor 330 to control the navigation of the visual object and the presentation of the visual object on the visualizing unit 350.

The client device may comprise a user input unit 360 for enabling the user to input at least one command (e.g. pressing the right/left keys on the computer keyboard) for effecting the navigation of the visual object (e.g. the horizontal/vertical rotation of the visual object). Alternatively, the visual object may rotate automatically, and the user's command is used only to specify the direction of the rotation of the visual object. In a further alternative, the visual object is configured to morph into the plurality of the visual modes. The user commands are supplied to the decoding processor 330 which may translate the commands, e.g. using the navigation control data, into instructions for changing the presentation of the visual object on the visualizing unit 350.

The decoding processor is configured to identify the current visual mode of the visual device, and/or the change of the visual modes, and determine which reference or sub-reference is currently selected.

The selected reference or sub-reference may further be used by the decoding processor to present it to the user, e.g. as the URL address in the address line 210 on the display screen 200, to initiate download of media content accessible by the (sub-)reference, to render the media content to the user, etc. In other words, depending on a purpose/application of the topology navigation, a further (predetermined) instruction is carried out by the decoding processor 330.

In the embodiment explained with reference to FIG. 3, the topology data are encoded by the server 310 and decoded by the client device 320. Alternatively, the topology data may be processed by an apparatus (not shown) for obtaining the topology data and processing the topology data to control the navigation of the topology through the visual object. The apparatus may be configured to analyze the topology (similarly as the data server 310) and map the visual modes on a scheme (navigation logic) for selection of the (sub-)references, and to further operate as the client device 320. The data server 310 is not needed in this case.

The apparatus may be incorporated into any of various consumer electronic devices such as a television set (TV set) with a cable, satellite or other link, a videocassette or HDD-recorder, a home cinema system, a portable CD player, a remote control device such as an iPronto remote control, a cell phone, etc. The advantages of the apparatus are especially apparent when it is incorporated in a portable device, because the portable device usually has a very limited display area.

The encoding processor of the data server 310 and/or the decoding processor 330 of the client device may be a well-known central processing unit (CPU) suitably arranged to implement the present invention and enable the operation of the data server or the client device, respectively. The memory unit 340 may be a known RAM (random access memory) memory module which is suitable to be read by the decoding processor 330. The user input unit 360 may be a keyboard, e.g. a well-known QWERTY computer keyboard, a pointing device, a TV remote control unit, etc. For example, the pointing devices are available in various forms such as a computer (wireless) mouse, light pen, touch pad, joystick, trackball, etc. The visualizing unit 360 may be any conventional means for presenting video information to the user, for example, a CRT (cathode ray tube), LCD (Liquid Crystal Display), LCOS (Liquid Crystal on Silicon) rear-projection technology, DLP (Digital Light Processing) television/Projector, a Plasma Screen display device, etc. A “computer program” is to be understood to mean any software product stored on a computer-readable medium, such as a floppy disk, downloadable via a network, such as the Internet, or marketable in any other manner.

The various program products may implement the functions of the system and method of the present invention and may be combined in several ways with the hardware or located in different devices. The invention can be implemented by means of hardware comprising several distinct elements, and by means of a suitably programmed computer. In the apparatus claim enumerating several means, several of these means can be embodied by one and the same item of hardware.

Variations and modifications of the described embodiments are possible within the scope of the inventive concept. For example, the system 300 in FIG. 3 is implemented in a single device (i.e. the apparatus). Alternatively, the system may comprise devices that are distributed and remotely located from each other.

The apparatus (not shown) may comprise a processor (not shown) for executing a software program to allow execution of the steps of the method of the present invention. The software may enable the apparatus of the present invention independently of where it is being run. To enable the apparatus, the processor may transmit the software program to, for example, the other (external) devices. The independent method claim and the computer program product claim may be used to protect the invention when the software is manufactured or exploited for running on the consumer electronic products. The external device may be connected to the processor using existing technologies, such as Blue-tooth, 802.11[a-g], etc. The processor may interact with the external device in accordance with the UPnP (Universal Plug and Play) standard.

Use of the verb ‘comprise’ and its conjugations does not exclude the presence of elements or steps other than those defined in a claim. In the claims, any reference signs placed between parentheses shall not be construed as limiting the claim. All details may be replaced with other technically equivalent elements.

1. A method of presenting a topology comprising a reference with one or more sub-references, the method comprising the steps of:
(110) obtaining topology data representing the topology, and
(120) processing the topology data so as to represent the topology by means of a visual object (250) associated with the reference, said object being configured to be visualized in any of a plurality of visual modes, wherein a specific one of the one or more sub-references is associated with a specific one of the plurality of visual modes.

2. The method of claim 1, further comprising a step (130) of visualizing the visual object in the specific one of the plurality of visual modes associated with the specific one of the one or more sub-references.

3. The method of claim 1, further comprising a step (140) of selecting a particular one of the one or more sub-references of the topology.

4. The method of claim 3, further comprising a step (140) of changing the visual mode in order to select another one of the sub-references.

5. The method of claim 1, comprising a step of assigning, to the specific one of the sub-references, a specific code for identifying the specific one of the plurality of visual modes.

6. The method of claim 5, further comprising the steps of:
obtaining the topology data comprising the specific code via a client device (320), and
visualizing the visual object in the specific one of the plurality of visual modes identified by the specific code.

7. The method of claim 1, wherein the reference is associated with a URL-address (Uniform Resource Locator) of a collection of information items, and respective ones of the sub-references are associated with a respective URL sub-address of a respective one of the information items.

8. An apparatus (310, 320) for presenting a topology comprising a reference with one or more sub-references, the apparatus comprising a data processor (310, 330) operative to obtain topology data representing the topology, and to process the topology data so as to represent the topology by means of a visual object (250) associated with the reference, said object being configured to be visualized in a plurality of visual modes, wherein a specific one of the one or more sub-references is associated with a specific one of the plurality of visual modes.

9. The apparatus of claim 8, further comprising:
a memory (340) for storing the visual object, and
a visualizing unit (350) for visualizing the object in the specific one of the visual modes.

10. A computer program product enabling a programmable device, when executing a computer program of said product, to implement the method of Claim 1.

11. A data structure for presenting a topology comprising a reference with one or more sub-references, wherein the data structure comprises topology data representing the topology, and wherein the topology data is operative to represent the topology by means of a visual object associated with the reference, the object being configured to be visualized in any of a plurality of visual modes, and wherein a specific one of the one or more sub-references is associated with a specific one of the plurality of visual modes.
